(19) United States
(12) Patent Application Publication
(10) Pub. No.: US 2010/0248698 A1
(43) Pub. Date: Sep. 30, 2010

(54) MOBILE TERMINAL DEVICE INLCUDING MOBILE CLOUD PLATFORM

(75) Inventors: Min Kyo In, Daejeon (KR); Seung Yun Lee, Daejeon (KR); Kangchan Lee, Daejeon (KR); Sung Han Kim, Daejeon (KR); Jong Hong Jeon, Daejeon (KR); Won Suk Lee, Daejeon (KR); Hae Won Jung, Daejeon (KR)

Correspondence Address: STAAS & HALSEY LLP, SUITE 700, 1201 NEW YORK AVENUE, N.W., WASHINGTON, DC, 20005, US

(73) Assignee: Electronics and Telecommunications Research Institute, Daejeon (KR)

(21) Appl. No.: 12/639,657

(22) Filed: Dec. 16, 2009

(30) Foreign Application Priority Data
Mar. 26, 2009 (KR) 10-2009-0025680

(51) Int. Cl. H04W 4/00

(52) U.S. Cl. 455/414.1

(57) ABSTRACT

Provided is a mobile terminal device including a mobile cloud platform. The mobile cloud platform includes a mobile cloud platform layer, a mobile cloud application layer, and a mobile cloud service layer. The mobile cloud platform layer virtualizes resources provided from the mobile terminal device. The mobile cloud application layer provides a service requested by a user to the user through a virtual mobile terminal user interface. The mobile cloud service layer provides the requested service constantly regardless of a change of mobile terminal environment. The mobile terminal device forms a mobile cloud together with other mobile terminal devices. Each of the mobile terminal devices includes a mobile cloud platform.

### CROSS-REFERENCE TO RELATED APPLICATIONS

This U.S. non-provisional patent application claims priority under 35 U.S.C. §119 of Korean Patent Application No. 10-2009-0025680, filed on Mar. 26, 2009, the entire contents of which are hereby incorporated by reference.

### BACKGROUND OF THE INVENTION

The present invention disclosed herein relates to mobile communication, and more particularly, to a platform structure for the mobile communication and a mobile terminal device including the same.

Recently, various mobile communication services such as broadcasting, multimedia image, E-mail, and multimedia message are provided. With the development of the mobile communication service, demands on provision of various services such as software, storages, computing resources, and contents without time-space limits are increasing.

In order to meet these demands, available resources of a mobile terminal are required to be maximally used. Also, tasks need to be performed beyond computing power/program/service that the terminal retains. However, since current mobile terminals are used only in voice communication and data communication that are main functions, their usage for job performance and program execution beyond the computing power of its own terminal is significantly deficient. Accordingly, a new method that can provide various services through service sharing, contents sharing, and computing resource sharing without limitation of the performance of a mobile terminal is required.

### SUMMARY OF THE INVENTION

The present invention provides a mobile cloud platform and a mobile terminal device including the same, which provide various services through service sharing, contents sharing, and computing resource sharing without limitation of the performance of a mobile terminal.

The present invention also provides a mobile cloud platform and a mobile terminal device including the same, which enable cooperation between mobile terminals under the mobile communication environment, and cooperation between a server cloud and a mobile cloud and extend a mobile platform to a cloud scope of a next-generation computing service.

Embodiments of the present invention provide mobile terminal devices comprising mobile cloud platforms, the mobile cloud platform including: a mobile cloud platform layer virtualizing resources provided from the mobile terminal device; a mobile cloud application layer providing a service requested by a user to the user through a virtual mobile terminal user interface; and a mobile cloud service layer constantly providing the requested service regardless of a change of mobile terminal environment, wherein the mobile terminal device forms a mobile cloud together with other mobile terminal devices, each of the mobile terminal devices comprising a mobile cloud platform.

In some embodiments, the requested service may be provided from at least one the mobile terminal device and the other mobile terminal devices.

In other embodiments, the mobile terminal device and the other mobile terminal devices may request services from each other through the mobile cloud platform.

In still other embodiments, the mobile terminal device and the other mobile terminal devices may mutually request services from a server cloud outside the mobile cloud through the mobile cloud platform.

In even other embodiments, the mobile terminal device and the other mobile terminal devices may form at least two mobile terminal groups in the mobile cloud.

In yet other embodiments, the at least two mobile terminal groups may form a cloud network, respectively.

In further embodiments, the mobile cloud may include a plurality of mobile cloud managers that analyze the request service and control data communication of the mobile terminal device.

In still further embodiments, the plurality of mobile cloud managers may form at least one mobile cloud manager groups comprising a cloud network.

In even further embodiments, the mutual service requests between the mobile terminal devices and the server cloud outside the mobile cloud may be performed through at least one of the mobile cloud managers.

In yet further embodiments, the mutual service requests between the mobile terminal device and the other mobile terminal devices may be performed without the plurality of mobile cloud managers.

In still further embodiments, the mobile cloud platform further may include a network layer that connects the mobile terminal device to the mobile cloud.

In even further embodiments, the mobile cloud platform layer may virtualize a plurality of resources supported in the mobile terminal device and the other mobile terminal devices as if the plurality of resources are provided in one service.

In yet further embodiment, the mobile cloud service layer may perform at least one of independency processing, offline supporting, real-time data synchronization, and context management with respect to each of the mobile terminal device and the other mobile terminal devices.

In other embodiments of the present invention, mobile terminal devices include mobile cloud platforms which include the mobile cloud platform comprising a mobile cloud platform layer virtualizing resources provided from the mobile terminal device, a mobile cloud application layer providing a service requested by a user to the user through a virtual mobile terminal user interface, and a mobile cloud service layer constantly providing the requested service regardless of a change of mobile terminal environment, wherein the mobile terminal device forms a mobile cloud together with other mobile terminal devices, each of the mobile terminal devices comprising a mobile cloud platform, the mobile cloud platform comprising at least one mobile terminal groups comprising the mobile terminal device and the other mobile terminal devices, and a mobile cloud manager group controlling data communication of the mobile terminal groups.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a diagram illustrating a configuration of a mobile cloud according to an embodiment of the present invention;

FIG. 2 is a diagram illustrating a detail configuration of a mobile terminal group of FIG. 1;

FIG. 3 is a diagram illustrating a detailed structure of a mobile cloud platform according to an embodiment of the present invention; and

FIG. 4 is a diagram illustrating a mobile cloud and a cloud system including the same according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

Hereinafter, exemplary embodiments of the present invention will be described in detail with reference to the accompanying drawings.

A mobile cloud platform according to an embodiment of the present invention includes a mobile cloud platform layer that virtualizes resources provided to a mobile terminal device, a mobile cloud application layer that provides services requested by a user to the user through a virtual mobile terminal user interface, and a mobile cloud service layer that provides the requested services constantly regardless of changes of the mobile terminal environment.

Mobile terminal devices using the mobile cloud platform includes one or more mobile terminal groups. The mobile terminal group forms a dual-structure mobile cloud including mobile cloud manager groups. The mobile cloud constitutes a mobile cloud system together with a server cloud. Here, the mobile terminal group forms a cloud network between terminals using a mobile cloud platform. Accordingly, cooperation between a cloud manager and a terminal, and cooperation between terminals are efficiently performed to provide various services through service sharing, contents sharing and computing resource sharing. The mobile cloud according to the embodiment is not only operated independently from a wire server cloud, but also has a cooperative structure with the server cloud. Accordingly, when the mobile cloud is difficult to provide services independently, a server cloud can request the services from the mobile cloud, and access/control resources of the server cloud from a terminal on the mobile cloud side without depending on performance of the mobile terminal.

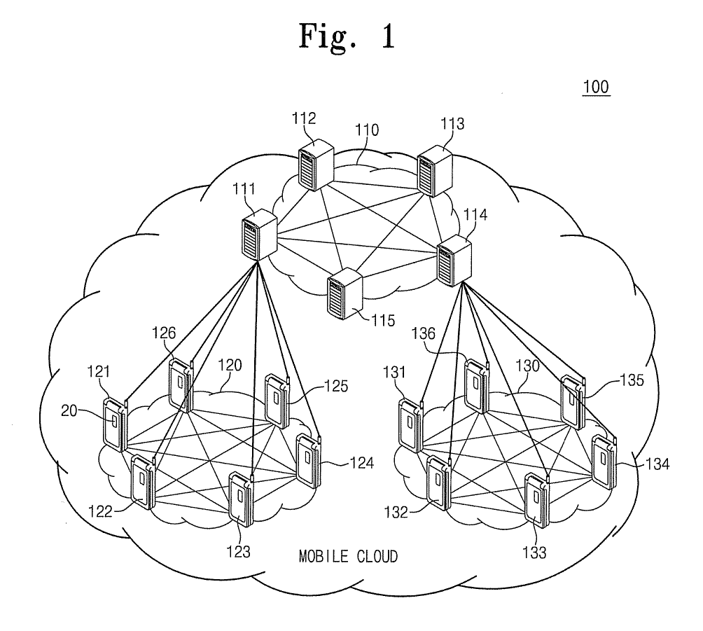

FIG. 1 is a diagram illustrating a configuration of a mobile cloud 100 according to an embodiment of the present invention.

Referring to FIG. 1, the mobile clued 100 has a two-layered structure of a mobile cloud manager group 110 and mobile terminal groups 120 and 130.

The mobile cloud manager group 110 serves as a manager that performs configuration/control/management on the mobile cloud 100. The mobile cloud manager group 110 exists in a mobile network, and performs access and data communication management with corresponding mobile terminals 121 through 126 and 131 through 137, and/or the mobile terminal groups 120 and 130. The mobile cloud manager group 110 includes a plurality of mobile cloud managers 111 through 115. A cloud network may be formed between the mobile cloud managers 111 through 115 included in the mobile cloud manager group 110. The types of the mobile cloud managers 111 through 115 included in the mobile cloud manager group 110 may be the same as or different from each other. The configuration and type of the mobile cloud managers 111 through 115 may be variously changed or modified without being limited to a specific configuration and type. Although the mobile cloud 110 includes one mobile cloud manager group 110 in FIG. 1, without being limited thereto, the mobile cloud manager group 110 may be divided into two or more mobile cloud manager groups.

The mobile cloud 100 may include one or more mobile terminal groups 120 and 130. Each of the mobile terminal groups 120 and 130 may be configured may be independently configured in the mobile cloud 100 by local environments (for example, physical environments or logical environments). Each of the mobile terminal groups 120 and 130 includes a plurality of mobile terminals 121 through 126 and 131 through 136. The types of the mobile terminals 121 through 126 and 131 through 136 may be the same as or different from each other for each of the mobile terminal groups 120 and 130. The configuration and type of the mobile terminals 121 through 126 and 131 through 136 may be variously changed or modified without being limited to a specific configuration and type. The number of the mobile terminal groups 120 and 130 provided in the mobile cloud 100 may be variously changed or modified.

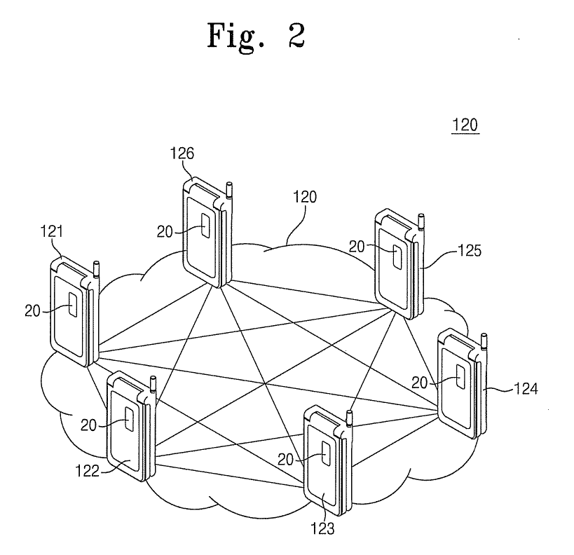

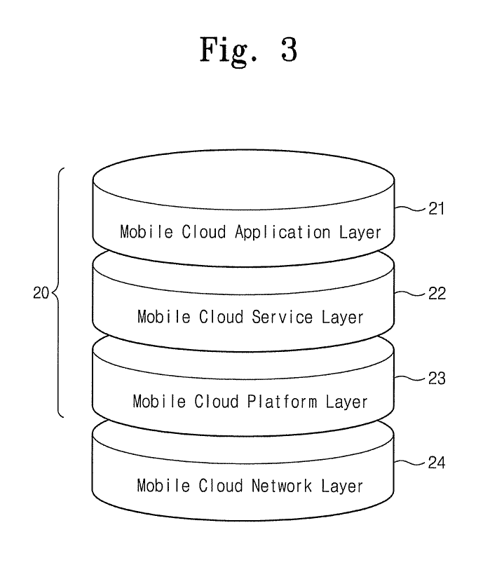

A cloud network may be formed between the mobile terminals 121 through 126 and 131 through 136 included in each of the mobile terminal groups 120 and 130. A mobile cloud platform (refer to 20 in FIGS. 2 and 3) is provided in each of the mobile terminals 121 through 127 and 131 through 136. As specifically described below, a cloud network is established between the mobile terminals 121 through 126 and 131 through 136 via the mobile cloud platforms. In this case, the network connection between the mobile terminals 121 through 127 and 131 through 136 may be established in various manners.

Operations of the mobile cloud manager group 110 and the mobile terminal groups 120 and 130 in the mobile cloud 100 will be described below.

If the mobile terminal 121 through 126 and 131 through 136 requests services, a corresponding mobile cloud manager 111 or 114 analyzes the request and instructs a necessary job. In this case, the mobile cloud managers 111 and 114 may deal with the above processing on their own or request cooperation from other cloud managers 112, 113 and 115 according to the type and magnitude of the requested service from the mobile terminals 121 through 126 and 131 through 136.

Upon request from a terminal, each of the mobile cloud managers 111 through 115 distributes a necessary job to terminal groups 120 and 130 being capable of cooperation with each other, or terminal using a mobile cloud platform, and performs functions of receiving/processing/delivering a performance result of each terminal. Each of the mobile terminals 121 through 126 and 131 through 136 may provide requested service using the control of the mobile cloud manager 111 through 115 or, if necessary, perform direct service provision therebetween without the control of the mobile cloud manager 111 through 115. In this case, examples of services that each terminal can perform include resource sharing, data sharing, computing power sharing, web service sharing, programming, which may be applied to various services.

The cloud network refers to a communication network that provides various softwares, security solutions, computing capability on demand to a user by integrating a plurality of data centers using a virtualization technology. In the cloud network, programs or documents are stored in a large computer or a service, and a user can perform a desired job by connecting to a service through various terminals such as PCs, mobile phones, and PDAs. Despite limitations of a terminal (especially, mobile terminal) in speed and size, a mobile cloud network according to this embodiment allows the terminal to effectively perform a desired task by remote.

Particularly, the mobile cloud 100 has a two-layered structure of the mobile cloud manager group 110 and the mobile terminal groups 120 and 130. A cloud network is formed between the mobile cloud managers 111 through 115 that the mobile cloud manager group 110 includes, and cloud networks are formed between the mobile terminals 121 through 126 and 131 through 136 that the mobile terminal groups 120 and 130, respectively. Accordingly, cooperation between the cloud manager and the mobile terminal, and cooperation between the mobile terminals can be more efficiently performed. According to the configuration of the mobile cloud 100, various services can be effectively provided through service sharing, contents sharing, and computing resource sharing without a limitation of the performance of the mobile terminal 121 through 126 and 131 through 136.

FIG. 2 is a diagram illustrating a detail configuration of a mobile terminal group of FIG. 1. A structure of a cloud network between the mobile terminals 121 through 126 is shown in FIG. 2.

Referring to FIG. 2, a mobile platform 20 may be provided in each of the mobile terminals 121 through 126. The mobile terminals 121 through 126 form a cloud network through the mobile platforms 20 provided in each of the mobile terminals 121 through 126. A network connection between the mobile terminals 121 through 126 may be achieved in various manners.

For example, the network connection between the mobile terminals 121 through 126 may be primarily achieved through a network that is used in voice and data communication by a communication provider. The network connection between the mobile terminals 121 through 126 may be secondarily achieved through an ah-hoc manner. The primary manner enables a configuration of a cloud network without a distance limitation between the mobile terminals 121 through 126. The secondary manner enables a configuration of a cloud network environment in consideration of physical effects between the mobile terminals 121 through 126. In this embodiment, both the primary and secondary manners may be considered in the configuration of the cloud network environment. The network according to the secondary manner, i.e., the ad-hoc manner is a temporary network that is freely constituted by a plurality of nodes having mobility. In the secondary manner, a temporary network may be constituted in a region where an infrastructure does not exist or a development of a network based on the infrastructure is not easy. Accordingly, the secondary manner has an advantage that can ensure service provision and sharing through the temporary network.

FIG. 3 is a diagram illustrating a detailed structure of a mobile cloud platform 20 according to an embodiment of the present invention.

Referring to FIG. 3, the mobile cloud platform 20 may include a mobile cloud application layer 21, a mobile cloud service layer 22, and a mobile cloud platform layer 23.

The mobile cloud application layer 21 provides service requested by a user to the user through a virtual mobile terminal user interface. For this, the mobile cloud application layer 21 provides an application service technology that indicates various services for a user, and a virtual mobile terminal user interface technology to a user through a mobile terminal.

The mobile cloud service layer 22 performs a function of constantly providing a requested service regardless of a change of the mobile terminal environment. For this, the mobile cloud service layer 22 provides at least one of an apparatus independency processing, an offline supporting technology, a real-time data synchronization technology, and a context management technology, which are necessary technologies for providing the same type of services in various mobile terminal environments.

The mobile cloud platform layer 23 performs a function of virtualizing resources that are provided from each mobile terminal device. A platform where resources of its own mobile terminal are virtualized is referred to as a resource virtualization platform. The mobile cloud platform layer 23 provides a function of virtualization that resource virtualization platforms of its own mobile terminal as well as other mobile terminals provide in one service. That is, the mobile cloud platform layer 23 virtualizes a plurality of resources that is provided from the mobile cloud network 100, allowing the plurality of services to be recognized as if they are provided in one service. The virtualization may be utilized for a useful application of information resources in a server or a system, and may be expanded to the virtualization of main hardware and applications. For example, the mobile cloud platform layer 23 integrates different resources that are spread over the mobile cloud network 100 into one virtualized resource, by virtually binding physical resources such as storage, server and network domain for an integrated management thereof.

Besides, the mobile cloud platform 20 may further include a mobile cloud network layer 24. The mobile cloud network layer 24, which is a network layer that a mobile terminal may be connected to, may be applied using various network connection methods.

As described above, a cloud network is built by a plurality of mobile terminals on the basis of the configuration of the mobile cloud platform 20 according to the embodiment. Referring to FIG. 1, a plurality of mobile terminals 121 through 126 and 131 through 136 may form one or more mobile terminal groups 120 and 130. The mobile terminal groups 120 and 130 may form the mobile cloud 100 together with the mobile cloud manager groups 110. Here, a plurality of mobile cloud managers 111 through 115 may also be connected to the mobile cloud manager group 110 through a cloud network.

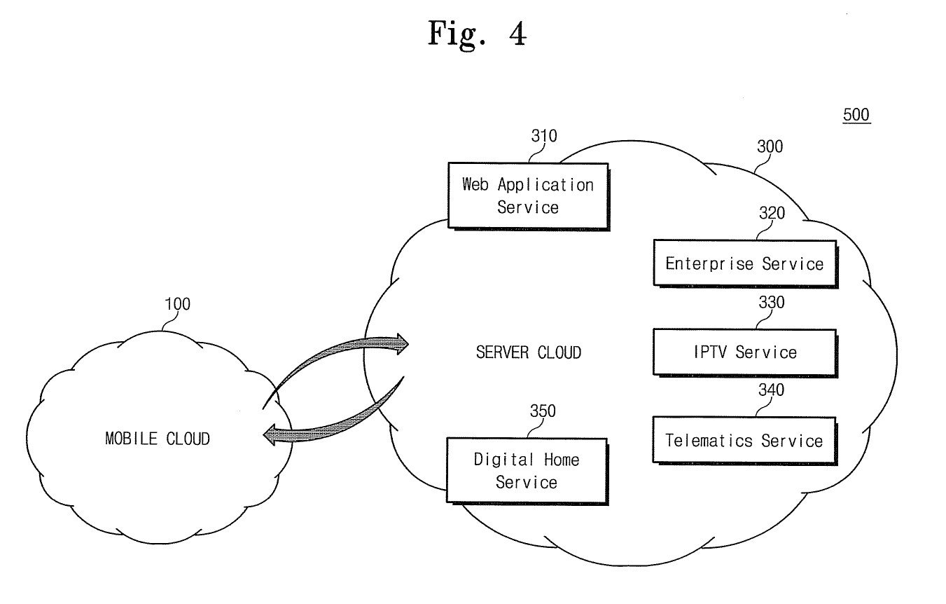

FIG. 4 is a diagram illustrating a mobile cloud 100 and a cloud system 500 including the same according to an embodiment of the present invention.

Referring to FIG. 4, the mobile cloud system 500 includes a mobile cloud 100 and a server cloud 300. The mobile cloud 100 may be connected to a server cloud 300 through a wired network as an example. The connection manner between the mobile cloud 100 and the server cloud 300 is not limited thereto. For example, the mobile cloud 100 may also be connected to the server cloud 300 through a wireless network. The detail configuration and operation of the mobile cloud 100 described in FIG. 4 are substantially identical to those described in FIGS. 1 and 2. The configuration of the mobile cloud platform 20 provided in the mobile cloud 100 are substantially identical to those described in FIG. 3. Accordingly, like reference numerals refer to like elements. Hereinafter, detailed descriptions of elements identical to those in FIG. 3 will be omitted.

The server cloud 300 is a subject that provides various services requested from a mobile terminal included in the mobile cloud 100. The server cloud 300 may provide various services such as web application services 310, enterprise service 320, Internet Protocol TV (IPTV) services 330, telematics services 340, and digital home services 350.

For example, the web application services 310 refers to services that link application programs through Internet by using eXtensible Mark-up Language (XML) and World Wide Web (WWW) that are standards of the extensible electronic document format. The enterprise service 320 is a web service reflecting a business language. The IPTV service 330 refers to a Triple Play Service (TPS) that provides a fused form of voice, data, and video rather than just delivers video streaming information or typical TV information through an IP network. Telematics service 340 refers to various mobile communication services such as location information, safe driving, entertainments, financial services, reservations and product purchases, which is a combination of wireless communication and Global Positioning System (GPS). The digital home service 350 provides various multimedia services such as security and entertainment without limitation of time and place by linking with a person out of home besides typical household monitoring and control. The services supported by the server cloud 300 may be virtualized through a mobile cloud platform 20. The virtualized service may be provided to each mobile terminal through a cloud network. The services of the server cloud 300 described above are mere examples, and may be modified into various forms without being limited to a specific form.

The mobile cloud 100 and the server cloud 300 that are connected through a wired network are independently operated. The mobile cloud 100 and the server cloud 300 have a structure being capable of cooperation with each other. For example, when it is difficult for the mobile cloud 100 to provide service independently, that is, a terminal of the mobile cloud 100 is going to perform at least one of the plurality of services 310 through 350 provided by the wired server cloud 300, a terminal of the mobile cloud 100 may request a corresponding service from the server cloud 300. When the terminal of the mobile cloud 100 is going to access/control resources of the server cloud 300, the mobile terminal may request a corresponding service. On the contrary, when a specified service for the mobile cloud 100 is performed, or when cooperation between the server cloud 300 and the mobile cloud 100 is necessary, the server cloud 300 may request a corresponding service from the mobile cloud 100. The cooperation between the server cloud 300 and the mobile cloud 100 may be achieved by the mobile cloud platform 20 according to an embodiment of the present invention.

According to the above configuration, various services, contents, and computing resources of the mobile cloud 100 and the server cloud 300 may be efficiently shared regardless of the performance of the mobile terminal. Accordingly, a user may use the mobile cloud platform 20 as a next-generation mobile middleware platform that is optimized for various mobile cloud services, and may use the mobile cloud platform 20 under ubiquitous environment through various service sharing, contents sharing, and computing resource sharing, regardless of the performance of the mobile terminals 121 through 126 and 131 through 136. Also, by allowing the services between the mobile terminals 121 through 126 and 131 through 136 to become a cloud platform, a next-generation mobile middleware platform development environment can be provided, enabling creation of various mobile application programs.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A mobile terminal device comprising a mobile cloud platform, the mobile cloud platform comprising:
a mobile cloud platform layer virtualizing resources provided from the mobile terminal device;
a mobile cloud application layer providing a service requested by a user to the user through a virtual mobile terminal user interface; and
a mobile cloud service layer constantly providing the requested service regardless of a change of mobile terminal environment,
wherein the mobile terminal device forms a mobile cloud together with other mobile terminal devices, each of the mobile terminal devices comprising a mobile cloud platform.

2. The mobile terminal device of claim 1, wherein the requested service is provided from at least one the mobile terminal device and the other mobile terminal devices.

3. The mobile terminal device of claim 1, wherein the mobile terminal device and the other mobile terminal devices requests services from each other through the mobile cloud platform.

4. The mobile terminal device of claim 1, wherein the mobile terminal device and the other mobile terminal devices mutually request services from a server cloud outside the mobile cloud through the mobile cloud platform.

5. The mobile terminal device of claim 1, wherein the mobile terminal device and the other mobile terminal devices form at least two mobile terminal groups in the mobile cloud.

6. The mobile terminal device of claim 5, wherein the at least two mobile terminal groups form a cloud network, respectively.

7. The mobile terminal device of claim 1, wherein the mobile cloud comprises a plurality of mobile cloud managers that analyze the request service and control data communication of the mobile terminal device.

8. The mobile terminal device of claim 7, wherein the plurality of mobile cloud managers form at least one mobile cloud manager groups comprising a cloud network.

9. The mobile terminal device of claim 7, wherein the mutual service requests between the mobile terminal devices and the server cloud outside the mobile cloud are performed through at least one of the mobile cloud managers.

10. The mobile terminal device of claim 7, wherein the mutual service requests between the mobile terminal device and the other mobile terminal devices are performed without the plurality of mobile cloud managers.

11. The mobile terminal device of claim 1, wherein the mobile cloud platform further comprises a network layer that connects the mobile terminal device to the mobile cloud.

12. The mobile terminal device of claim 1, wherein the mobile cloud platform layer virtualizes a plurality of resources supported in the mobile terminal device and the other mobile terminal devices as if the plurality of resources are provided in one service.

13. The mobile terminal device of claim 1, wherein the mobile cloud service layer performs at least one of independency processing, offline supporting, real-time data synchronization, and context management with respect to each of the mobile terminal device and the other mobile terminal devices.

14. A mobile terminal device comprising a mobile cloud platform,
the mobile cloud platform comprising a mobile cloud platform layer virtualizing resources provided from the mobile terminal device, a mobile cloud application layer providing a service requested by a user to the user through a virtual mobile terminal user interface, and a mobile cloud service layer constantly providing the requested service regardless of a change of mobile terminal environment,
wherein the mobile terminal device forms a mobile cloud together with other mobile terminal devices, each of the mobile terminal devices comprising a mobile cloud platform, the mobile cloud platform comprising at least one mobile terminal groups comprising the mobile terminal device and the other mobile terminal devices, and a mobile cloud manager group controlling data communication of the mobile terminal groups.
